(19) United States
(12) Patent Application Publication
(10) Pub. No.: US 2023/0254726 A1
(43) Pub. Date: Aug. 10, 2023

(54) COMMUNICATION METHOD AND COMMUNICATION DEVICE

(71) Applicant: Woven Planet Holdings, Inc., Tokyo (JP)

(72) Inventors: Toshinobu Watanabe, Tokyo-to (JP); Takahiro Ito, Tokyo-to (JP); Ryokichi Onishi, Tokyo-to (JP)

(73) Assignee: Woven Planet Holdings, Inc., Tokyo (JP)

(21) Appl. No.: 18/155,161

(22) Filed: Jan. 17, 2023

(30) Foreign Application Priority Data
Feb. 9, 2022 (JP) 2022-018829

(51) Int. Cl. H04W 28/02; H04W 76/15

(52) U.S. Cl. CPC H04W 28/0231; H04W 76/15; H04W 28/021

(57) ABSTRACT

In communication between a moving body and an external device, one of a plurality of communication modes is selected, and transmission target data are transmitted from the moving body to the external device based on the selected communication mode. The plurality of communication modes include: a line selection mode that selects one of communication lines available to the moving body and transmits the transmission target data by using the selected one communication line; and a redundant transmission mode that transmits same packets of the transmission target data in parallel by concurrently using multiple communication lines available to the moving body. In the mode selection process, whether reliable communication is necessary is determined based on an environment in which the moving body is placed. The redundant transmission mode is selected when the reliable communication is necessary, while the line selection mode is selected when the reliable communication is not necessary.

### CROSS-REFERENCE TO RELATED APPLICATION

This application claims priority to Japanese Patent Application No. 2022-018829 filed on Feb. 9, 2022, the entire contents of which are incorporated by reference herein.

### BACKGROUND

### Technical Field

The present disclosure relates to a technique for performing communication between a moving body and an external device.

### Background Art

Patent Literature 1 discloses a wireless communication system in which wireless communication is performed between a base station and a subscriber station. A communication device provided in the base station or the subscriber station includes a first wireless communication means, a second wireless communication means, and a radio frequency switching means. The first wireless communication means performs the wireless communication by using a first frequency band that is equal to or higher than a quasi-millimeter wave. The second wireless communication means performs the wireless communication by using a second frequency band that is lower than the first frequency band and has less radio wave attenuation due to rainfall. The radio frequency switching means normally selects the first radio communication means, and selects the second radio communication means when communication interruption is detected.

Patent Literature 2 discloses a transmission device. The transmission device includes a first transmission means for transmitting a packet via a first communication line, a second transmission means for transmitting a packet via a second communication line, a packet generation means for copying the packet, a monitoring means for monitoring communication states of the first and second communication lines, and a control means. The control means transmits the duplicated two or more packets by using at least one of the first and second communication lines according to the monitored communication states.

Patent Literature 3 discloses a route setting device that sets a route of a moving body having a plurality of operation modes. The route setting device sets the route of the moving body so as to pass through an area satisfying a requirement of communication quality that is determined according to an operation mode of the moving body.

Patent Literature 4 discloses a remote operation device for remotely operating a target device. The remote operation device acquires a quality of communication between the target device and the remote operation device, and sets authority of the remote operation device regarding the operation of the target device on the basis of the communication quality.

### LIST OF RELATED ART

Patent Literature 1: Japanese Laid-Open Patent Application No. JP-2002-335201
Patent Literature 2: International Publication No. WO2017/175826
Patent Literature 3: Japanese Laid-Open Patent Application No. JP-2020-165832
Patent Literature 4: International Publication No. WO2020/202372

### SUMMARY

Regarding communication between a moving body such as a vehicle and a robot and an external device, it is considered that there is a need for reducing a communication cost as much as possible. Meanwhile, depending on an environment in which the moving body is placed, it is considered that there is also a need for highly reliable communication. It is important to appropriately balance low costs and high reliability in light of such needs.

An object of the present disclosure is to provide a technique capable of appropriately balancing high reliability and low costs regarding communication between a moving body and an external device.

A first aspect is directed to a communication method for performing communication between a moving body and an external device.

The communication method includes:

a mode selection process that selects one of a plurality of communication modes; and

a data transmission process that transmits transmission target data from the moving body to the external device based on the selected communication mode.

The plurality of communication modes include:

a line selection mode that selects one of communication lines available to the moving body and transmits the transmission target data by using the selected one communication line; and

a redundant transmission mode that transmits same packets of the transmission target data in parallel by concurrently using multiple communication lines available to the moving body.

The mode selection process includes:

determining whether or not reliable communication is necessary based on environmental information indicating an environment in which the moving body is placed;

selecting the redundant transmission mode when it is determined that the reliable communication is necessary; and

selecting the line selection mode when it is determined that the reliable communication is not necessary.

A second aspect is directed to a communication device that is installed on a moving body and communicates with an external device.

The communication device includes a communication controller configured to select one of a plurality of communication modes and to transmit transmission target data to the external device based on the selected communication mode.

The plurality of communication modes include:

a line selection mode that selects one of communication lines available to the moving body and transmits the transmission target data by using the selected one communication line; and

a redundant transmission mode that transmits same packets of the transmission target data in parallel by concurrently using multiple communication lines available to the moving body.

The communication controller is further configured to:

determine whether or not reliable communication is necessary based on environmental information indicating an environment in which the moving body is placed;

select the cost-oriented selection mode when the communication quality of the first communication line satisfies the predetermined level; and

select the quality-oriented selection mode when the communication quality of the first communication line does not satisfy the predetermined level.

According to the present disclosure, the plurality of communication modes include the line selection mode that is low-cost and the redundant transmission mode that is highly reliable and low-latency. Whether or not to give priority to the reliable communication depends on the environment in which the moving body is placed. Therefore, whether or not the reliable communication is necessary is determined based on the environmental information indicating the environment in which the moving body is placed. When it is determined that the reliable communication is necessary, the redundant transmission mode is actively selected. On the other hand, when it is determined that the reliable communication is not necessary, the line selection mode is actively selected. The redundant transmission mode is selected only when the reliable communication is necessary, and the line selection mode is selected in the other cases, which can prevent an unnecessary increase in communication cost. That is, it is possible to appropriately balance high reliability and low costs.

### BRIEF DESCRIPTION OF DRAWINGS

FIG. 1 is a conceptual diagram showing an overview of a communication system according to an embodiment of the present disclosure;

FIG. 2 is a conceptual diagram for explaining an application example of a communication system according to an embodiment of the present disclosure;

FIG. 3 is a block diagram showing a configuration example of a communication system according to an embodiment of the present disclosure;

FIG. 4 is a block diagram showing a concrete example of a communication system according to an embodiment of the present disclosure;

FIG. 5 is a conceptual diagram showing an example of available areas of a plurality of communication lines;

FIG. 6 is a conceptual diagram for explaining a line selection mode according to an embodiment of the present disclosure;

FIG. 7 is a conceptual diagram for explaining a redundant transmission mode according to an embodiment of the present disclosure;

FIG. 8 is a conceptual diagram for explaining a split transmission mode according to an embodiment of the present disclosure;

FIG. 9 is a flowchart showing processing performed by a communication controller according to an embodiment of the present disclosure;

FIG. 10 is a flowchart showing a mode selection process (Step S100) according to an embodiment of the present disclosure;

FIG. 11 is a table diagram showing examples of an environment requiring reliable communication according to an embodiment of the present disclosure;

FIG. 12 is a flowchart showing an example of Step S120 according to an embodiment of the present disclosure;

FIG. 13 is a flowchart showing a modification example of Step S120 according to an embodiment of the present disclosure;

FIG. 14 is a block diagram showing a configuration example of a moving body according to an embodiment of the present disclosure;

FIG. 15 is a block diagram showing a configuration example of a communication controller according to an embodiment of the present disclosure;

FIG. 16 is a block diagram showing a functional configuration example of a communication controller according to an embodiment of the present disclosure; and

FIG. 17 is a conceptual diagram for explaining a combination mode according to an embodiment of the present disclosure.

### EMBODIMENTS

Embodiments of the present disclosure will be described with reference to the accompanying drawings.

### 1. Communication System

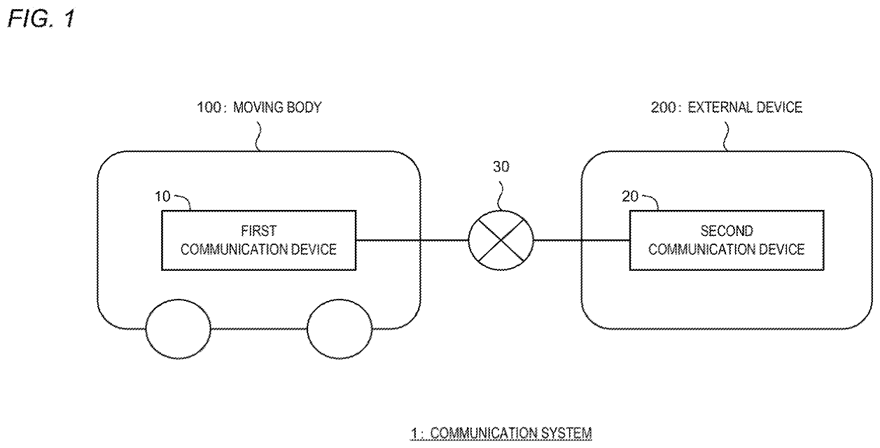

FIG. 1 is a conceptual diagram showing an overview of a communication system 1 according to the present embodiment. The communication system 1 includes a first communication device 10, a second communication device 20, and a communication network 30. The first communication device 10 and the second communication device 20 are connected to each other via the communication network 30. The first communication device 10 and the second communication device 20 are able to communicate with each other via the communication network 30.

The first communication device 10 is installed on a moving body 100. Examples of the moving body 100 include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

The second communication device 20 is installed on an external device 200 outside the moving body 100. A type of the external device 200 is not limited in particular. For example, the external device 200 is a management server for managing the moving body 100. As another example, the external device 200 may be a remote support device that remotely supports an operation of the moving body 100. As yet another example, the external device 200 may be a moving body different from the moving body 100.

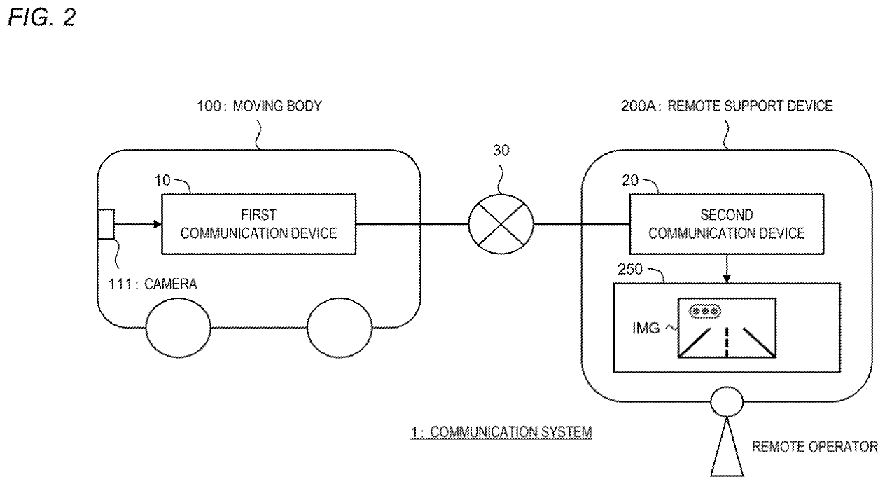

FIG. 2 is a conceptual diagram for explaining an application example of the communication system 1. In the example shown in FIG. 2, the communication system 1 is utilized for “remote support” that remotely supports an operation of the moving body 100. More specifically, a camera 111 is installed on the moving body 100. The camera 111 images a situation around the moving body 100 to acquire an image IMG. The first communication device 10 transmits the image IMG to a remote support device 200A being an example of the external device 200. The second communication device 20 of the remote support device 200A receives the image IMG from the moving body 100. The remote support device 200A displays the received image IMG on a display device 250. A remote operator views the image IMG displayed on the display device 250 to grasp the situation around the moving body 100 and remotely supports the operation of the moving body 100. Examples of the remote support by the remote operator include recognition support, decision support, remote driving (remote operation), and the like. An instruction from the remote operator is transmitted from the second communication device 20 to the first communication device 10 of the moving body 100. The moving body 100 operates according to the instruction from the remote operator.

According to the present embodiment, the first communication device 10 installed on the moving body 100 is configured to be capable of communicating with the external device 200 via a plurality of communication lines. The first communication device 10 transmits transmission target data to the external device 200 by using a necessary number of communication lines among the plurality of communication lines. The transmission target data may be streaming data.

More specifically, the first communication device 10 supports multiple communication carriers and multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like. A communication cost differs among the multiple types of communication methods. In the example above, the wireless LAN method is the lowest and the common cellular method is the highest.

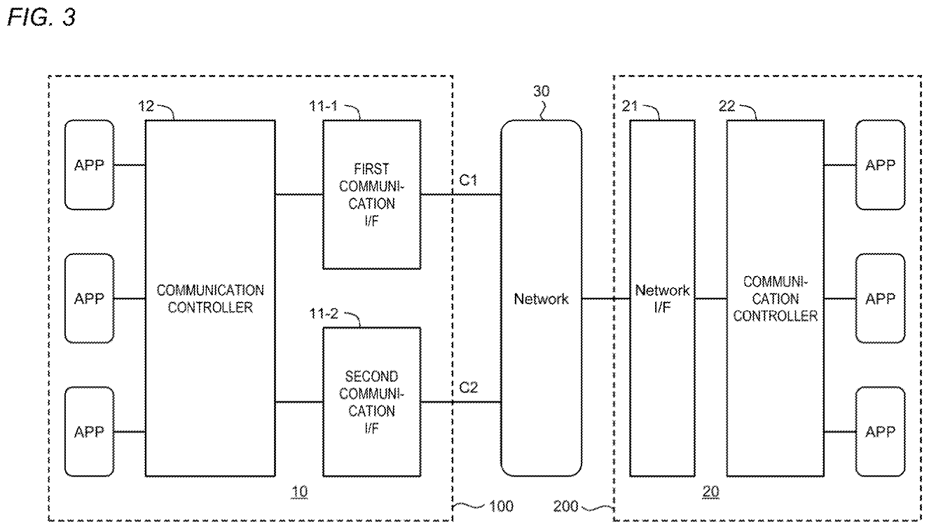

FIG. 3 is a block diagram showing a configuration example of the communication system 1 according to the present embodiment. The first communication device 10 includes a plurality of communication interfaces 11 and a communication controller 12.

The plurality of communication interfaces 11 are associated with different communication carriers or different communication methods, respectively. A plurality of communication lines are established via the plurality of communication interfaces 11, respectively. In other words, the plurality of communication lines are associated with the plurality of communication interfaces 11, respectively. For example, a first communication interface 11-1 performs communication via a first communication line C1 based on a first communication method. A second communication interface 11-2 performs communication via a second communication line C2 based on a second communication method. It should be noted that the plurality of communication interfaces 11 may be realized by different physical interfaces, or may be realized by a combination of a common physical interface and different logical interfaces.

The communication controller 12 is provided to control data transmitted and received by at least one application running on the moving body 100. For example, the communication controller 12 allocates the transmission target data to one or more of the plurality of communication interfaces 11 (communication lines) to be used. Then, the communication controller 12 transmits the transmission target data to the external device 200 via the allocated communication interface 11 (i.e., the allocated communication line).

The second communication device 20 includes a network interface 21 and a communication controller 22. The network interface 21 is connected to the communication network 30 and communicates with the first communication device 10.

The communication controller 22 is provided to control data transmitted and received by at least one application running on the external device 200. For example, the communication controller 22 receives data transmitted from the first communication device 10 via the network interface 21. Then, the communication controller 22 outputs the received data to a destination application.

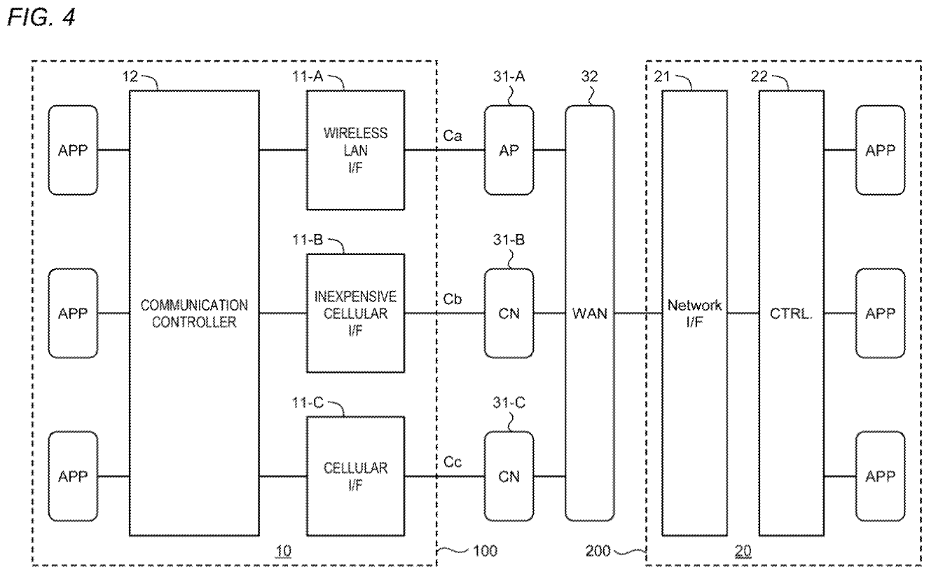

FIG. 4 is a block diagram showing a concrete example of the communication system 1 according to the present embodiment. The plurality of communication interfaces 11 of the first communication device 10 include a wireless LAN interface 11-A, an inexpensive cellular interface 11-B, and a cellular interface 11-C. The wireless LAN interface 11-A performs communication via a communication line Ca based on a wireless LAN method. The wireless LAN interface 11-A is connected to a communication network 32 (e.g., WAN) via an access point 31-A. The inexpensive cellular interface 11-B performs communication via a communication line Cb based on an inexpensive cellular method. The inexpensive cellular interface 11-B is connected to the communication network 32 via a cellular network 31-B. The cellular interface 11-C performs communication via a communication line Cc based on a common cellular system. The cellular interface 11-C is connected to the communication network 32 via a cellular network 31-C. In the example shown in FIG. 4, the communication cost is lower in an order of the communication line Ca based on the wireless LAN method, the communication line Cb based on the inexpensive cellular method, and the communication line Cc based on the common cellular method.

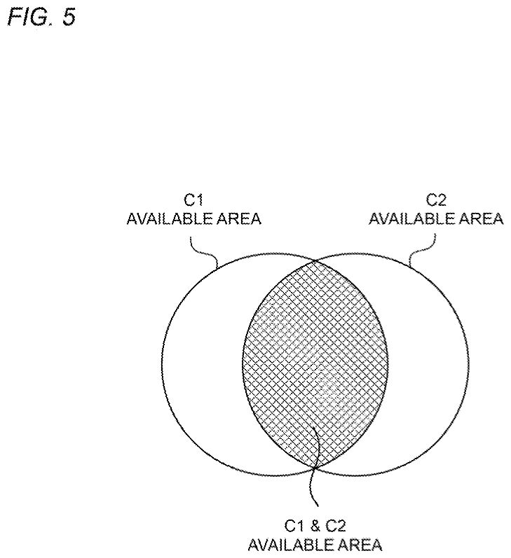

FIG. 5 is a conceptual diagram showing an example of available areas of a plurality of communication lines. The available area of the first communication line C1 and the available area of the second communication line C2 partially overlap each other. In the overlap area, both the first communication line C1 and the second communication line C2 are available at the same time. In the other available areas, only one of the first communication line C1 and the second communication line C2 is available.

### 2. Multiple Communication Modes

The communication controller 12 of the first communication device 10 according to the present embodiment has a plurality of communication modes, and selects one of the plurality of communication modes to perform the communication. Hereinafter, the plurality of communication modes of the communication controller 12 will be described.

### 2-1. Line Selection Mode

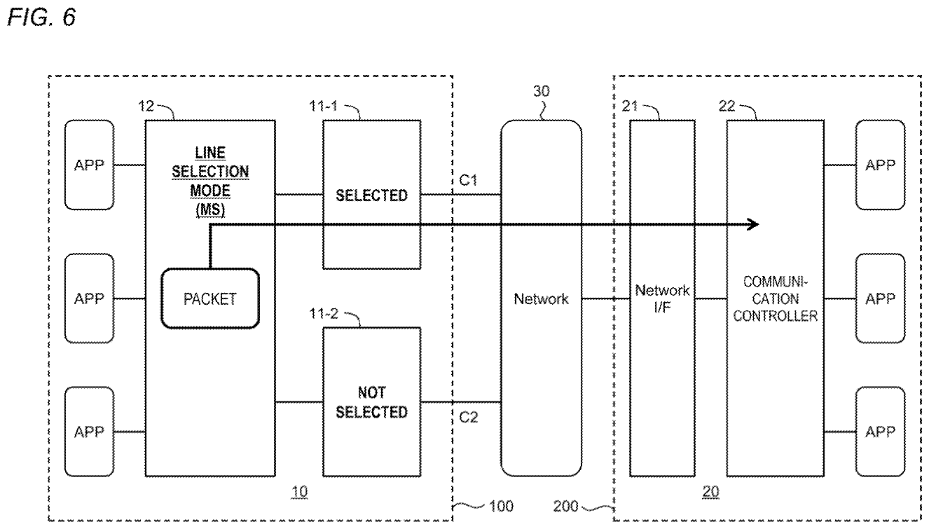

FIG. 6 is a conceptual diagram for explaining a “line selection mode MS.” The line selection mode MS selects one of communication lines available to the moving body 100 and transmits the transmission target data by using the selected one communication line. Data transmission by an unselected communication line is stopped. In the example shown in FIG. 6, the communication controller 12 selects the first communication line C1 and transmits packets of the transmission target data by using the first communication line C1. Since multiple communication lines are not simultaneously used but one communication line is selectively used, the line selection mode MS is relatively low in cost.

The line selection mode MS may be further classified into the following two modes: a “cost-oriented selection mode MS1” and a “quality-oriented selection mode MS2.”

### 2-1-1. Cost-Oriented Selection Mode

The cost-oriented selection mode MS1 selects one communication line with the lowest cost from the communication lines available to the moving body 100 and transmits the transmission target data by using the selected one communication line. It can be said that the cost-oriented selection mode MS1 is the most excellent communication mode from a viewpoint of low cost.

### 2-1-2. Quality-Oriented Selection Mode

The quality-oriented selection mode MS2 selects one communication line with the highest communication quality from the communication lines available to the moving body 100 and transmits the transmission target data by using the selected one communication line. Here, examples of the communication quality include a communication bandwidth (communication speed, bit rate), radio wave intensity, round trip time (RTT), bit error rate, and the like. The communication quality may be any of a real-time measured value, an estimated value, and a predicted value based on a past communication result database. It can be said that the quality-oriented selection mode MS2 is a communication mode having a good balance of communication quality and low cost.

### 2-2. Redundant Transmission Mode

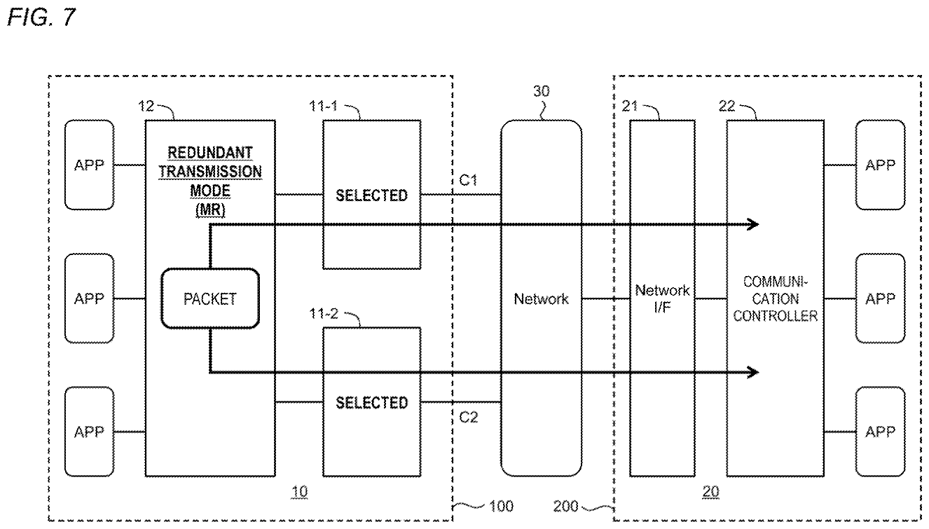

FIG. 7 is a conceptual diagram for explaining a “redundant transmission mode MR.” The redundant transmission mode MR transmits same packets of the transmission target data in parallel by concurrently using multiple communication lines available to the moving body 100. In the example shown in FIG. 7, the communication controller 12 selects both the first communication line C1 and the second communication line C2, and transmits same packets in parallel by concurrently using the first communication line C1 and the second communication line C2.

The communication controller 22 of the second communication device 20 on the receiving side may receive the same packets via multiple communication lines. In this case, the communication controller 22 selects a same packet received earliest and discards another same packet received later. For example, the communication controller 12 on the transmitting side gives identification information (e.g. an identification number) in a header of each transmission packet. The communication controller 22 on the receiving side grasps a reception history of each packet based on the identification information in the header of each received packet. Then, the communication controller 22 selects one received earliest and discards another received later among the same packets received via the multiple communication lines.

As described above, in the case of the redundant transmission mode MR, the same packets are simultaneously transmitted in parallel via multiple communication lines. Therefore, high communication reliability is achieved, and a communication delay is reduced as much as possible. In other words, the redundant transmission mode MR is excellent in terms of high reliability and low latency. However, since the multiple communication lines are used at the same time, the cost increases.

2-3. Split transmission Mode

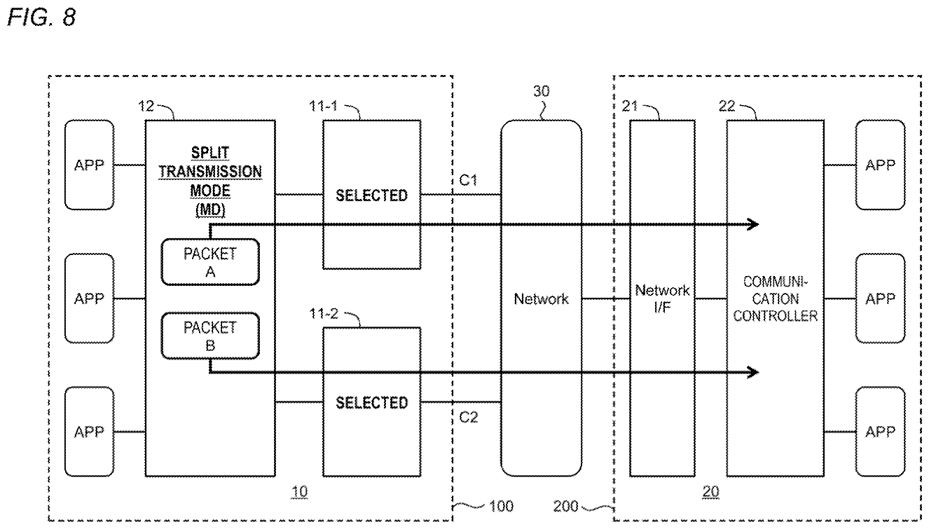

FIG. 8 is a conceptual diagram for explaining a “split transmission mode MD.” The split transmission mode MD splits and transmits the transmission target data by concurrently using multiple communication lines available to the moving body 100. In the example shown in FIG. 8, the communication controller 12 selects both the first communication line C1 and the second communication line C2, and distributes packets of the transmission target data to the first communication line C1 and the second communication line C2. A distribution ratio is set, for example, according to a ratio of communication bandwidth between the first communication line C1 and the second communication line C2. In the case of the split transmission mode MD, a total communication bandwidth (throughput) is increased. However, since the multiple communication lines are used at the same time, the cost increases.

### 3. Mode Selection Process

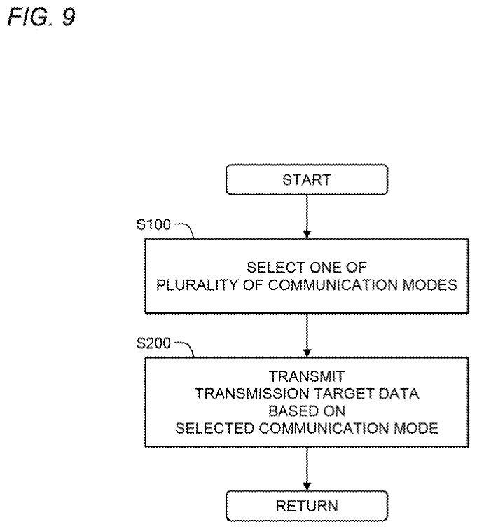

FIG. 9 is a flowchart showing processing performed by the communication controller 12 according to the present embodiment. In Step S100, the communication controller 12 executes a “mode selection process” that selects one of the plurality of communication modes. In subsequent Step S200, the communication controller 12 executes a “data transmission process” that transmits the transmission target data to the external device 200 based on the selected communication mode.

As described below, the inventor of the present application has studied the mode selection process in detail.

First, there is a general tendency that developers desire to increase throughput as much as possible. In other words, the developers tend to be orientated toward achieving high throughput using the split transmission mode MD. However, a viewpoint of the developer does not necessarily coincide with a viewpoint of a user. Users do not necessarily desire to increase the throughput going so far as paying a high communication fee. Moreover, in an area where only a single communication line is available, the split transmission mode MD cannot be used (see FIG. 5).

Regarding the communication between the moving body 100 such as a vehicle and a robot and the external device 200, it is considered that there is a need for reducing the communication cost as much as possible in a wider area. Meanwhile, depending on an environment in which the moving body 100 is placed, it is considered that there is also a need for highly reliable communication. It is important to appropriately balance low costs and high reliability in light of such needs.

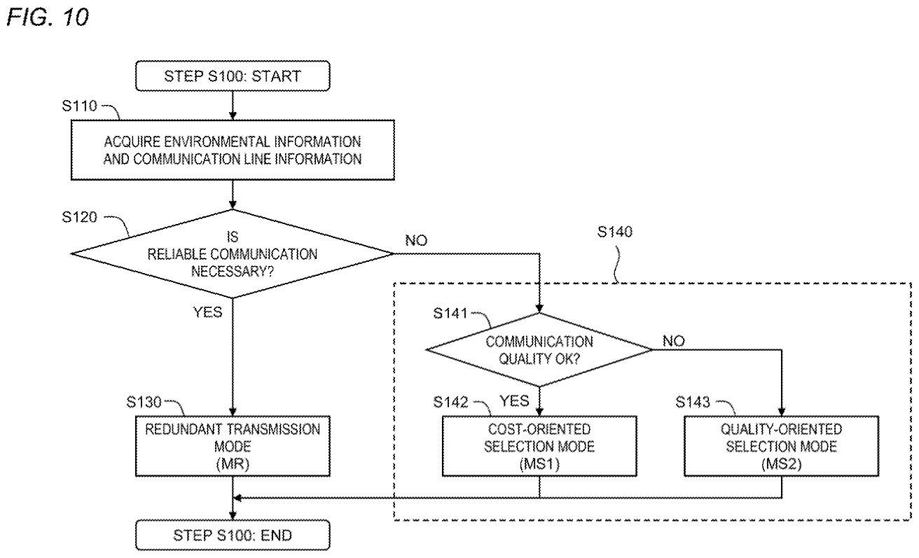

In view of the above, according to the present embodiment, the “line selection mode MS” and the “redundant transmission mode MR” are mainly used. The mode selection process (Step S100) according to the present embodiment will be described below with reference to FIG. 10.

### 3-1. Step S110

In Step S110, the communication controller 12 acquires environmental information ENV and communication line information CLN. The environmental information ENV indicates an environment in which the moving body 100 is placed. A concrete example of the environmental information ENV will be described later. The communication line information CLN indicates communication lines currently available to the moving body 100, and the costs and communication qualities of the communication lines. Examples of the communication quality include a communication bandwidth (communication speed, bit rate), radio wave intensity, RTT, a bit error rate, and the like. The communication quality may be any of a real-time measured value, an estimated value, and a predicted value based on a past communication result database.

### 3-2. Step S120

In Step S120, the communication controller 12 executes a “determination process” that determines whether or not reliable communication is necessary. Whether or not to give priority to the reliable communication also depends on the environment in which the moving body 100 is placed. Therefore, the communication controller 12 determines whether or not the reliable communication is necessary based on the environmental information ENV.

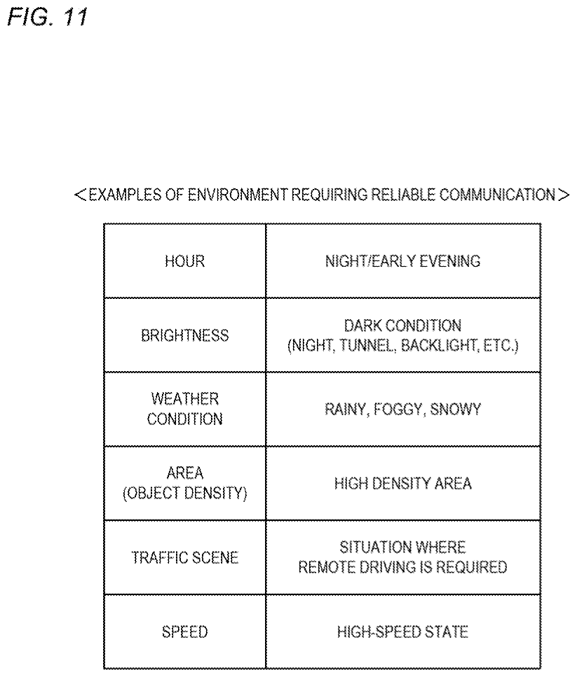

FIG. 11 is a table diagram showing examples of the environment in which the reliable communication is necessary. Examples of a determination condition for determining whether or not the reliable communication is necessary include an hour, brightness, a weather condition, an area (object density), a traffic scene, a speed, and the like.

In a first example, the environmental information ENV indicates an “hour” (e.g., morning, noon, evening, and night) at a position where the moving body 100 is present. For example, when the hour is evening or night, the communication controller 12 determines that the reliable communication is necessary. Otherwise, the communication controller 12 determines that the reliable communication is not necessary.

In a second example, the environmental information ENV indicates “brightness” recognized by the moving body 100. For example, the brightness is low during night, in a tunnel, and in a backlight condition. For example, in a case of a dark condition in which the brightness is less than a threshold, the communication controller 12 determines that the reliable communication is necessary. On the other hand, in a case of a bright condition in which the brightness is equal to or higher than the threshold, the communication controller 12 determines that the reliable communication is not necessary.

In a third example, the environmental information ENV indicates a “weather condition” (e.g., sunny, cloudy, rainy, foggy, snowy) at a position where the moving body 100 is present. For example, when the weather condition is any of rainy, foggy, and snowy, the communication controller 12 determines that the reliable communication is necessary. Otherwise, the communication controller 12 determines that the reliable communication is not necessary.

In a fourth example, the environmental information ENV indicates an “object density” around the moving body 100. The object density indicates how dense objects such as people and other vehicles are around the moving body 100. For example, in a case of a high-density area (e.g., a shopping street) where the object density is equal to or higher than a threshold, the communication controller 12 determines that the reliable communication is necessary. On the other hand, in a case of a low-density area where the object density is less than the threshold, the communication controller 12 determines that the reliable communication is not necessary.

In a fifth example, the environmental information ENV indicates a “traffic scene” in which the moving body 100 is placed. Here, a case where the moving body 100 performs automated driving will be considered in particular. During the automated driving, there is a possibility that the moving body 100 requests a remote operator for a remote support, depending on the traffic scene in which the moving body 100 is placed. The remote support includes: (1) “recognition/decision support” in which the remote operator temporarily performs recognition or action decision instead of the moving body 100; and (2) “remote driving” in which the remote operator remotely drives (operates) the moving body 100. For example, there is a possibility that the moving body 100 requests the remote operator for the recognition/decision support at an intersection, a road construction section, a section where there is guidance by a guide person, and the like. On the other hand, in a traffic scene in which continuing the automated driving is impossible (for example, a complicated road structure, outside an ODD (Operational Design Domain), or the like), the moving body 100 requests the remote operator for the remote driving. In the case of the traffic scene requiring the remote driving, the communication controller 12 determines that the reliable communication is necessary. On the other hand, in a case of a traffic scene not requiring the remote driving, the communication controller 12 determines that the reliable communication is not necessary.

In a sixth example, the environmental information ENV indicates a “speed” of the moving body 100. For example, in a high-speed state in which the speed is equal to or higher than a threshold, the communication controller 12 determines that the reliable communication is necessary. On the other hand, when the speed is lower than the threshold, the communication controller 12 determines that the reliable communication is not necessary.

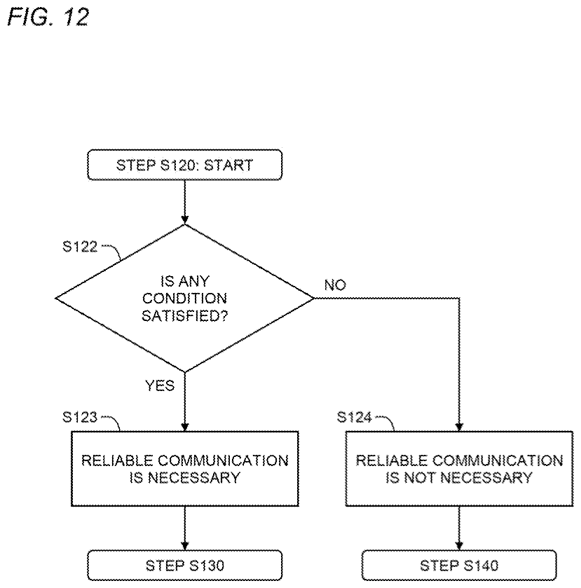

FIG. 12 is a flowchart showing an example of Step S120 (determination process). In Step S122, the communication controller 12 performs the determinations of the first to sixth examples described above. When at least one of the reliable communication conditions is satisfied (Step S122; Yes), the communication controller 12 determines that the reliable communication is necessary (Step S123). In this case, the processing proceeds to Step S130. Otherwise (Step S122; No), the communication controller 12 determines that the reliable communication is not necessary (Step S124). In this case, the processing proceeds to Step S140.

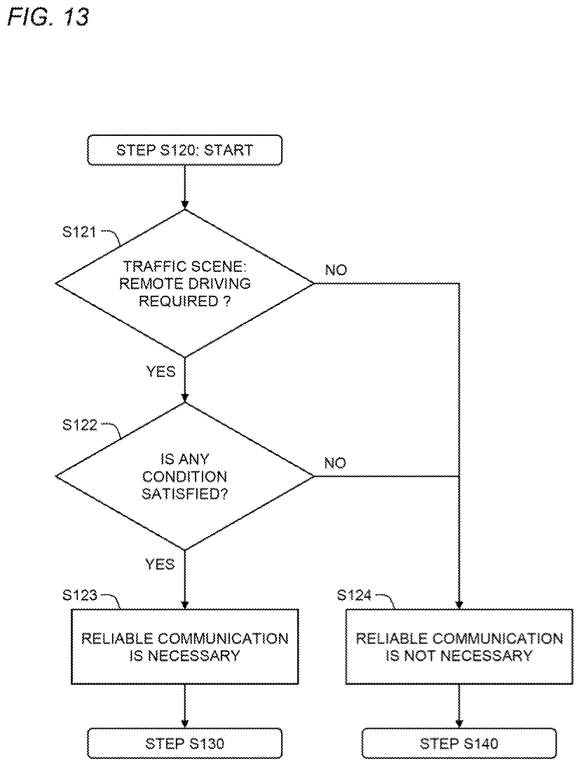

FIG. 13 is a flowchart showing a modification example of Step S120 (determination process). First, in Step S121, the communication controller 12 performs the determination of the fifth example described above. When the traffic scene requires the remote driving (Step S121; Yes), the processing proceeds to Step S122 described above. On the other hand, when the traffic scene does not require the remote driving (Step S121; No), the processing skips Step S122 and proceeds to Step S124. That is, when the remote driving is unnecessary, the communication controller 12 uniformly determines that the reliable communication is unnecessary. It can be said that this modification example relies on the high automated driving capability of the moving body 100.

### 3-3. Step S130

Returning to FIG. 10, in Step S130, the communication controller 12 selects the “redundant transmission mode MR (see FIG. 7)” from the plurality of communication modes.

### 3-4. Step S140

On the other hand, in Step S140, the communication controller 12 selects the “line selection mode MS (see FIG. 6)” from the plurality of communication modes. Step S140 may include the following processing.

In Step S141, the communication controller 12 recognizes, based on the communication line information CLN, a communication line with the lowest cost among the communication lines available to the moving body 100. It is assumed here that the communication line with the lowest cost is the first communication line C1. The communication controller 12 determines, based on the communication line information CLN, whether or not a communication quality of the first communication line C1 satisfies a predetermined level. For example, the communication controller 12 determines whether or not a throughput of the first communication line C1 is equal to or higher than a predetermined threshold. When the communication quality of the first communication line C1 satisfies the predetermined level (Step S141; Yes), the processing proceeds to Step S142. On the other hand, when the communication quality of the first communication line C1 does not satisfy the predetermined level (Step S141; No), the processing proceeds to Step S143.

In Step S142, the communication controller 12 selects the “cost-oriented selection mode MS1” from the plurality of communication modes.

In Step S143, the communication controller 12 selects the “quality-oriented selection mode MS2” from the plurality of communication modes.

### 3-5. Effects

As described above, according to the present embodiment, the plurality of communication modes include the line selection mode MS that is low-cost and the redundant transmission mode MR that is highly reliable and low-latency. Whether or not to give priority to the reliable communication depends on the environment in which the moving body 100 is placed. Therefore, whether or not the reliable communication is necessary is determined based on the environmental information ENV indicating the environment in which the moving body 100 is placed. When it is determined that the reliable communication is necessary, the redundant transmission mode MR is actively selected. On the other hand, when it is determined that the reliable communication is not necessary, the line selection mode MS is actively selected. The redundant transmission mode MR is selected only when the reliable communication is necessary, and the line selection mode MS is selected in the other cases, which can prevent an unnecessary increase in communication cost. That is, according to the present embodiment, it is possible to appropriately balance high reliability and low costs in the communication between the moving body 100 and the external device 200.

It should be noted that according to the related arts disclosed in the above-mentioned Patent Literatures, decrease in communication state and communication quality is taken into consideration, but the environment in which the moving body 100 is placed is not taken into consideration. In the prior art, the line selection mode MS or the redundant transmission mode MR is never selected according to the environment in which the moving body 100 is placed.

### 4. Configuration Example

### 4-1. Configuration Example of Moving Body

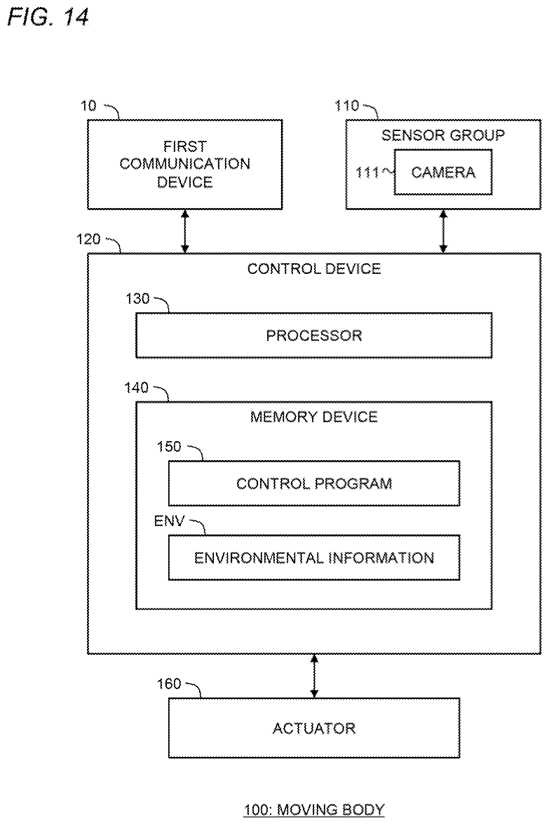

FIG. 14 is a block diagram showing a configuration example of the moving body 100 according to the present embodiment. The moving body 100 is, for example, a vehicle. The moving body 100 includes the first communication device 10, a sensor group 110, a control device (controller) 120, and an actuator 160.

The first communication device 10 communicates with the external device 200 outside the moving body 100. For example, the first communication device 10 communicates with the remote support device 200A (see FIG. 2) for performing the remote support of the moving body 100.

The sensor group 110 includes a recognition sensor, a state sensor, a position sensor, and the like. The recognition sensor recognizes (detects) a situation around the moving body 100. Examples of the recognition sensor include the camera 111 (see FIG. 2), a laser imaging detection and ranging (LIDAR), a radar, and the like. The state sensor detects a state of the moving body 100. The state sensor includes a speed sensor, an acceleration sensor, a yaw rate sensor, a steering angle sensor, and the like. The position sensor detects a position of the moving body 100. As the position sensor, a global navigation satellite system (GNSS) is exemplified.

The control device 120 controls the moving body 100. The control device 120 includes one or more processors 130 (hereinafter simply referred to as a processor 130) and one or more memory devices 140 (hereinafter simply referred to as a memory device 140). The processor 130 executes a variety of processing. For example, the processor 130 includes a central processing unit (CPU). The memory device 140 stores a variety of information necessary for the processing by the processor 130. Examples of the memory device 140 include a volatile memory, a nonvolatile memory, a hard disk drive (HDD), a solid state drive (SSD), and the like. The control device 120 may include one or a plurality of electronic control units (ECUs).

A control program 150 is a computer program that is executed by the processor 130. The functions of the control device 120 are implemented by the processor 130 executing the control program 150. The control program 150 is stored in the memory device 140. The control program 150 may be recorded on a non-transitory computer-readable recording medium.

The control device 120 uses the sensor group 110 to acquire the environmental information ENV indicating the environment in which the moving body 100 is placed. The environmental information ENV is stored in the memory device 140. For example, the environmental information ENV includes surrounding situation information, state information, position information, and the like.

The surrounding situation information is information indicating the situation around the moving body 100 and is acquired by the recognition sensor. For example, the surrounding situation information includes the image IMG captured by the camera 111. As another example, the surrounding situation information may include point cloud information acquired by the LIDAR.

The surrounding situation information further includes object information regarding an object around the moving body 100. Examples of the object include a pedestrian, a bicycle, another vehicle (a preceding vehicle, a following vehicle, a parked vehicle, and the like), a road structure (a white line, a crosswalk, a curb, a guardrail, and the like), a traffic light, a sign, a fallen object, and the like. The object information indicates a relative position and a relative speed of the object with respect to the moving body 100. For example, analyzing the image IMG captured by the camera makes it possible to identify an object and to calculate a relative position of the object. It is also possible to identify an object and to acquire a relative position and a relative speed of the object on the basis of the point cloud information obtained by the LIDAR. The object information may include a moving direction and a moving speed of the object.

The surrounding situation information may include the hour (e.g., morning, noon, evening, and night) at the position where the moving body 100 is present. For example, the hour is recognized by analyzing the image IMG captured by the camera 111.

The surrounding situation information may include the brightness recognized by the moving body 100. The brightness is acquired by analyzing the image IMG captured by the camera 111. For example, the brightness is low during night, in a tunnel, and in a backlight condition.

The surrounding situation information may include the weather condition (e.g., sunny, cloudy, rainy, foggy, snowy) at the position where the moving body 100 is present. The weather condition is acquired, for example, by analyzing the image IMG captured by the camera 111. As another example, rain and snow can be detected based on laser reflectivity in the LIDAR measurement.

The surrounding situation information may include the object density around the moving body 100. The object density is an index indicating how dense objects such as people and other vehicles are around the moving body 100. The object density can be calculated based on the object information described above.

The surrounding situation information may include the traffic scene in which the moving body 100 is placed (e.g., an intersection, a roadwork section, guidance by a guide, a complex road structure, etc.). The traffic scene can be recognized on the basis of the object information described above.

The state information is information indicating the state of the moving body 100 and is detected by the state sensor. Examples of the state of moving body 100 include a speed, an acceleration, a yaw rate, a steering angle, and the like.

The state information may include a current driving mode (automated driving/remote driving/manual driving) of the moving body 100. The state information may indicate whether the moving body 100 requires the remote driving (i.e, whether it is impossible to continue the automated driving).

The position information is information indicating the position of the moving body 100 and is acquired by the position sensor. Further, highly accurate position information may be acquired by performing a well-known self-position estimation processing (localization) using the object information.

The actuator 160 is a device for moving the moving body 100. The control device 120 moves the moving body 100 by controlling the actuator 160.

For example, when the moving body 100 is a vehicle, the actuator 160 is a travel device that causes the vehicle to travel. The travel device includes a steering device, a drive device, and a braking device. For example, the steering device includes an electric power steering (EPS) device. Examples of the drive device include an engine, an electric motor, an in-wheel motor, and the like. The control device 120 executes vehicle travel control including steering control, driving control, and braking control by controlling the travel device.

The control device 120 may perform automated driving control based on the environmental information ENV. More specifically, the control device 120 generates a travel plan based on the environmental information ENV. Examples of the travel plan include maintaining a current travel lane, making a lane change, turning right or left, avoiding an obstacle, and the like. Further, the control device 120 generates, based on the environmental information ENV, a target trajectory necessary for the vehicle to travel in accordance with the travel plan. The target trajectory includes a target position and a target velocity. Then, the control device 120 performs the vehicle travel control so that the vehicle follows the target trajectory.

When the remote support is performed (see FIG. 2), the control device 120 transmits vehicle information including at least the image IMG to the remote support device 200A via the first communication device 10. In addition, the control device 120 receives instruction information indicating an instruction by the remote operator from the remote support device 200A via the first communication device 10. Then, the control device 120 performs the vehicle travel control in accordance with the received instruction information.

### 4-2. Configuration Example of Communication Controller

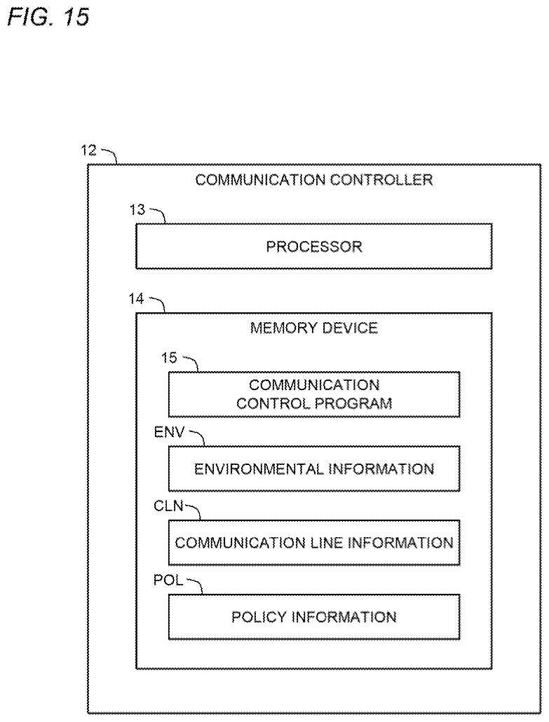

FIG. 15 is a block diagram showing a configuration example of the communication controller 12 according to the present embodiment. The communication controller 12 includes one or more processors 13 (hereinafter, simply referred to as a processor 13) and one or more memory devices 14 (hereinafter, simply referred to as a memory device 14). The processor 13 executes a variety of processing. For example, the processor 13 includes a CPU. The memory device 14 stores a variety of information necessary for the processing by the processor 13. Examples of the memory device 14 include a volatile memory, a nonvolatile memory, an HDD, an SSD, and the like.

The environmental information ENV, the communication line information CLN, and policy information POL are stored in the memory device 14. The environmental information ENV indicates the environment in which the moving body 100 is placed. The communication line information CLN indicates communication lines currently available to the moving body 100, and the costs and communication qualities of the communication lines. The policy information POL indicates the conditions under which the reliable communication is required as exemplified in FIG. 11.

A communication control program 15 is a computer program executed by the processor 13. The functions of the communication controller 12 are implemented by the processor 13 executing the communication control program 15. The communication control program 15 is stored in the memory device 14. The communication control program 15 may be recorded on a non-transitory computer-readable recording medium.

It should be noted that the communication controller 12 shown in FIG. 15 and the control device 120 shown in FIG. 14 may be at least partially the same. That is, the processor 13 of the communication controller 12 and the processor 130 of the control device 120 may be at least partially the same. The memory 14 of the communication controller 12 and the memory 140 of the control device 120 may be at least partially the same.

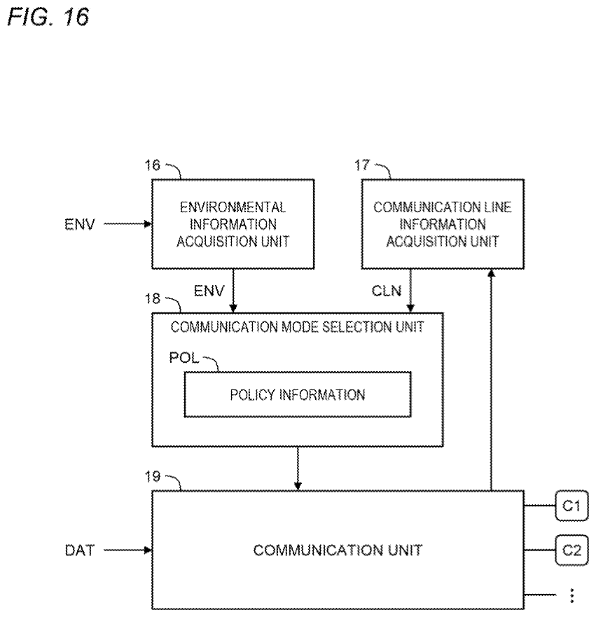

FIG. 16 is a block diagram showing an example of a functional configuration of the communication controller 12 according to the present embodiment. The communication controller 12 includes an environmental information acquisition unit 16, a communication line information acquisition unit 17, a communication mode selection unit 18, and a communication unit 19. These functional blocks are realized by a cooperation between the processor 13 executing the communication control program 15 and the memory device 14.

The environmental information acquiring unit 16 acquires the environmental information ENV from the control device 120 (FIG. 10; Step S110). The environmental information acquisition unit 16 outputs the environmental information ENV to the communication mode selection unit 18.

The communication line information acquiring unit 17 generates the communication line information CLN based on a result of communication by the communication unit 19 (FIG. 10; Step S110). The communication line information acquisition unit 17 outputs the communication line information CLN to the communication mode selection unit 18.

The communication mode selection unit 18 holds the policy information POL. The communication mode selection unit 18 executes the mode selection process that selects one of the plurality of communication modes based on the environmental information ENV, the policy information POL, and the communication line information CLN (FIG. 10; Steps S120 to S140). The communication mode selection unit 18 notifies the communication unit 19 of the selected communication mode.

The communication unit 19 receives the transmission target data DAT. The transmission target data DAT may be streaming data. Based on the communication mode selected by the communication mode selection unit 18, the communication unit 19 selects a communication line to be used and transmits the transmission target data DAT to the external device 200 (FIG. 9; Step S200).

### 5. Combination Mode

The plurality of communication modes of the communication controller 12 may include a “combination mode MC” based on the video coding standard H.264/SVC. The combination mode MC is a combination of the redundant transmission mode MR and the line selection mode MS.

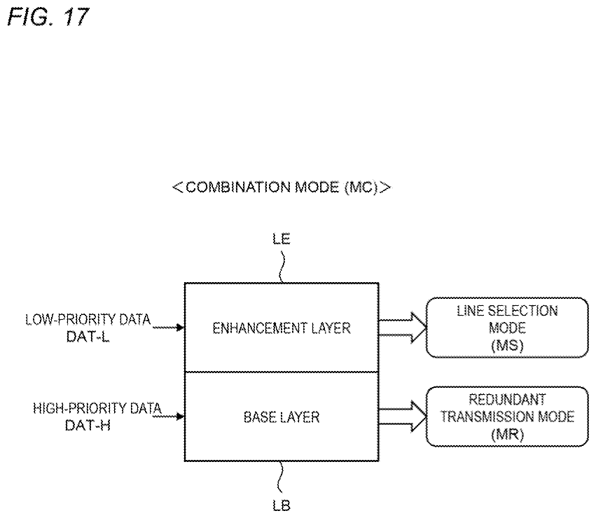

FIG. 17 is a conceptual diagram for explaining the combination mode MC. According to H.264/SVC, a data structure of the transmission target data DAT (video stream) includes a base layer LB and an enhancement layer LE. The transmission target data DAT is classified into high-priority data DAT-H and low-priority data DAT-L. For example, the high-priority data DAT-H is minimum data necessary for reproduction of the video stream. The high-priority data DAT-H is allocated to the base layer LB. On the other hand, the low-priority data DAT-L is allocated to the enhancement layer LE.

The communication controller 12 transmits the high-priority data DAT-H of the base layer LB based on the redundant transmission mode MR and transmits the low-priority data DAT-L of the enhancement layer LE based on the line selection mode MS. For example, the communication controller 12 selects two communication lines in descending order of communication quality based on the communication line information CLN. Then, the communication controller 12 transmits the high-priority data DAT-H of the base layer LB in the redundant transmission mode MR by using the selected two communication lines. Further, the communication controller 12 transmits the low-priority data DAT-L of the enhancement layer LE in the line selection mode MS by using another one communication line. Whether to select the cost-oriented selection mode MS1 or the quality-oriented selection mode MS2 is determined in the same manner as the method shown in FIG. 10.

According to the combination mode MC, it is possible to improve video quality at low cost while at least ensuring continuity of video reproduction.

What is claimed is:

1. A communication method for performing communication between a moving body and an external device, the communication method comprising:
a mode selection process that selects one of a plurality of communication modes; and
a data transmission process that transmits transmission target data from the moving body to the external device based on the selected communication mode, wherein
the plurality of communication modes include:
a line selection mode that selects one of communication lines available to the moving body and transmits the transmission target data by using the selected one communication line; and
a redundant transmission mode that transmits same packets of the transmission target data in parallel by concurrently using multiple communication lines available to the moving body, and
the mode selection process includes:
determining whether or not reliable communication is necessary based on environmental information indicating an environment in which the moving body is placed;
selecting the redundant transmission mode when it is determined that the reliable communication is necessary; and
selecting the line selection mode when it is determined that the reliable communication is not necessary.

2. The communication method according to claim 1, wherein
the line selection mode includes:
a cost-oriented selection mode that selects a first communication line with a lowest cost from the communication lines available to the moving body; and
a quality-oriented selection mode that selects one with highest communication quality from the communication lines available to the moving body, and
the selecting the line selection mode includes:
determining whether or not a communication quality of the first communication line satisfies a predetermined level;
selecting the cost-oriented selection mode when the communication quality of the first communication line satisfies the predetermined level; and
selecting the quality-oriented selection mode when the communication quality of the first communication line does not satisfy the predetermined level.

3. The communication method according to claim 1, wherein
the environmental information indicates at least one of an hour, brightness, a weather condition, an object density, a traffic scene, and a speed of the moving body.

4. The communication method according to claim 3, wherein
when the hour is night, it is determined that the reliable communication is necessary.

5. The communication method according to claim 3, wherein
when the brightness is less than a threshold, it is determined that the reliable communication is necessary.

6. The communication method according to claim 3, wherein
when the weather condition is any of rainy, foggy, and snowy, it is determined that the reliable communication is necessary.

7. The communication method according to claim 3, wherein
when the object density around the moving body is equal to or higher than a threshold, it is determined that the reliable communication is necessary.

8. The communication method according to claim 3, wherein
when the traffic scene requires remote driving of the moving body, it is determined that the reliable communication is necessary.

9. The communication method according to claim 3, wherein
when the traffic scene does not require remote driving of the moving body, it is determined that the reliable communication is not necessary.

10. The communication method according to claim 3, wherein
when the speed of the moving body is equal to or higher than a threshold, it is determined that the reliable communication is necessary.

11. The communication method according to claim 1, wherein
the moving body is a target of remote support by a remote operator, and
the external device is a remote support device on a side of the remote operator.

12. A communication device that is installed on a moving body and communicates with an external device,
the communication device comprising a communication controller configured to select one of a plurality of communication modes and to transmit transmission target data to the external device based on the selected communication mode, wherein
the plurality of communication modes include:
a line selection mode that selects one of communication lines available to the moving body and transmits the transmission target data by using the selected one communication line; and
a redundant transmission mode that transmits same packets of the transmission target data in parallel by concurrently using multiple communication lines available to the moving body, and
the communication controller is further configured to:
determine whether or not reliable communication is necessary based on environmental information indicating an environment in which the moving body is placed;
select the cost-oriented selection mode when the communication quality of the first communication line satisfies the predetermined level; and
select the quality-oriented selection mode when the communication quality of the first communication line does not satisfy the predetermined level.
